(19) United States
(12) Patent Application Publication
(10) Pub. No.: US 2014/0250583 A1
(43) Pub. Date: Sep. 11, 2014

(54) Anti-bacterial Foot Bath Liner Device

(71) Applicants: Emanuel P. Sergi, Staten Island, NY (US); Anna Maltese-Sergi, Staten Island, NY (US)

(72) Inventors: Emanuel P. Sergi, Staten Island, NY (US); Anna Maltese-Sergi, Staten Island, NY (US)

(21) Appl. No.: 13/792,533

(22) Filed: Mar. 11, 2013

(51) Int. Cl. A47K 3/00; A61H 35/00

(52) U.S. Cl. CPC A47K 3/001; A61H 35/006
USPC 4/580

(57) ABSTRACT

An anti-bacterial and anti-fungal foot bath liner device for lining a pedicure or foot treatment tub while providing antibacterial properties to prevent transmission of infection includes a liner. The liner has a perimeter edge, an upper surface and a lower surface. The upper surface of the liner is impregnated with silver nanoparticles wherein the liner is configured for preventing bacterial infection. The liner is configured for positioning in a tub wherein the upper surface of the liner lines the tub.

### BACKGROUND OF THE DISCLOSURE

### Field of the Disclosure

The disclosure relates to liner devices and more particularly pertains to a new liner device for lining a pedicure or foot treatment tub while providing antibacterial and anti-fungal properties to prevent transmission of infection.

### SUMMARY OF THE DISCLOSURE

An embodiment of the disclosure meets the needs presented above by generally comprising a liner. The liner has a perimeter edge, an upper surface and a lower surface. The upper surface of the liner is impregnated with silver nanoparticles wherein the liner is configured for preventing bacterial and fungal infection. The liner is configured for positioning in a tub wherein the upper surface of the liner lines the tub.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a anti-bacterial foot bath liner device according to an embodiment of the disclosure.

FIG. 2 is a front view of an embodiment of the disclosure.

FIG. 3 is a cross-sectional view of an embodiment of the disclosure taken along line 3-3 of FIG. 2.

FIG. 4 is an exploded view of an embodiment of the disclosure in use.

FIG. 5 is a top view of an embodiment of the disclosure in use.

### DESCRIPTION OF THE PREFERRED EMBODIMENT

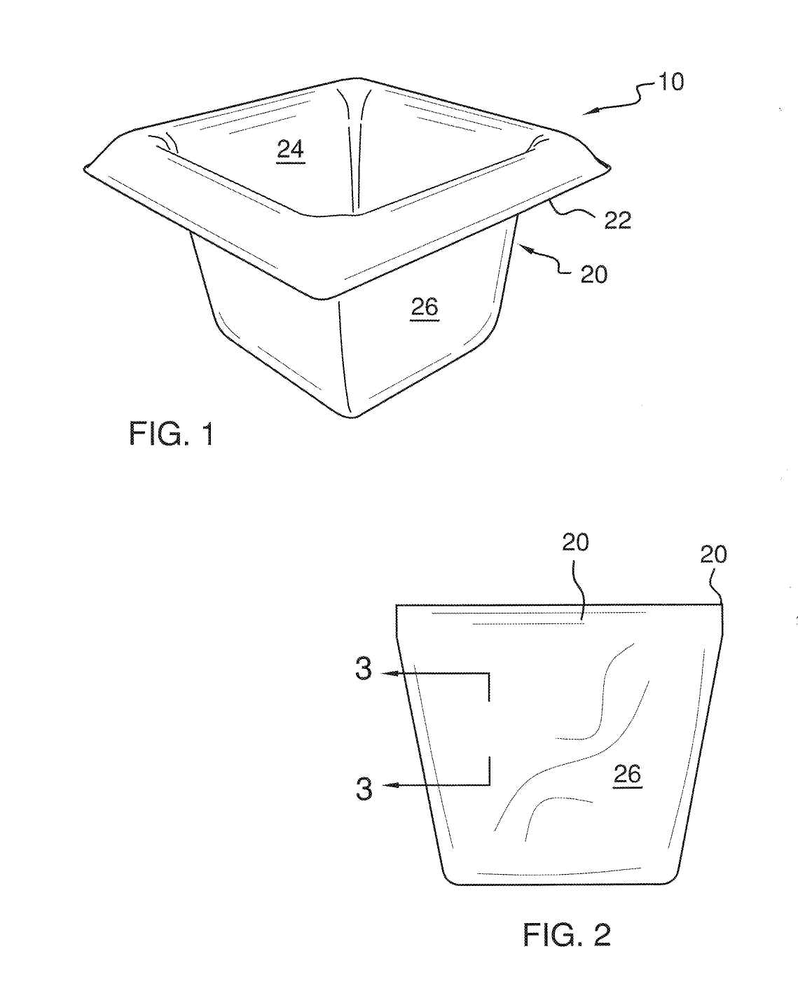

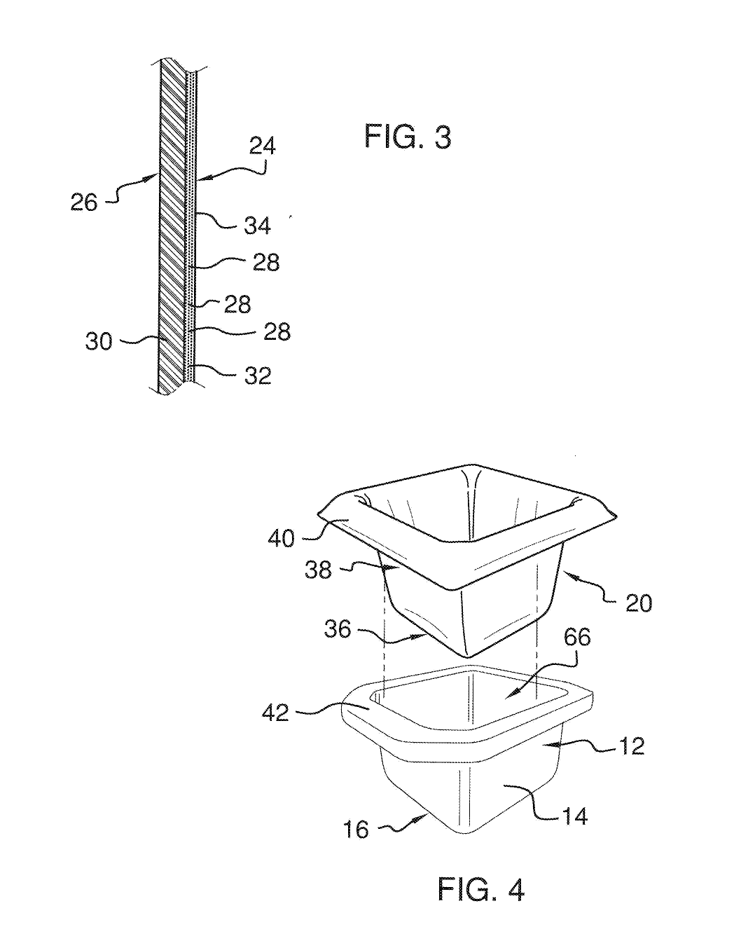

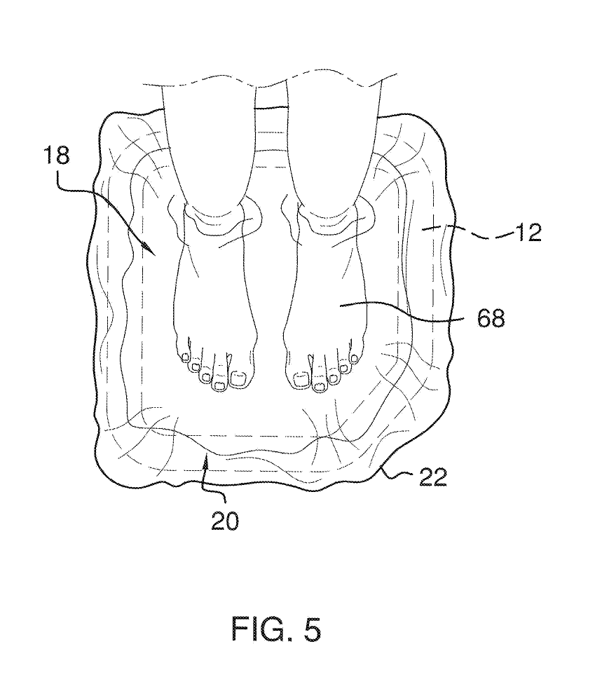

With reference now to the drawings, and in particular to FIGS. 1 through 5 thereof, a new liner device embodying the principles and concepts of an embodiment of the disclosure and generally designated by the reference numeral 10 will be described.

As best illustrated in FIGS. 1 through 5, the anti-bacterial and anti-fungal foot bath liner device 10 generally comprises a tub 12 having a peripheral wall 14 and a closed bottom 16 wherein the tub 12 is configured for holding a liquid 18. A flexible liner 20 has a perimeter edge 22, an upper surface 24 and a lower surface 26. The upper surface 24 of the liner 20 is impregnated with silver nanoparticles 28 wherein the liner 20 is configured for preventing bacterial infection. The liner 20 is positioned in the tub 12 wherein the upper surface 24 of the liner 20 lines the tub 12. The liner 20 has a lower layer 30 and an upper layer 32. The silver nanoparticles 28 impregnate the upper layer 32 of the liner 20. The upper surface 24 of the liner 20 is formed by an outwardly facing surface 34 of the upper layer 32. The liner 20 is formed to include a planar lower portion 36 and a perimeter wall 38 extending upwardly from the lower portion 36.

A lip 40 extends from the perimeter wall 38 of the liner 20, and the lip 40 is configured for extending over an upper edge 42 of the tub 12. The silver nanoparticles 28 are particles of silver or silver oxide between 1 nanometer and 100 nanometers in size.

In use, the device 10 provides for a method 50 of preventing infection transmission in a foot bath. A step 52 of having the tub 12 and the liner 20 wherein the upper surface 24 of the liner 20 is impregnated with silver nanoparticles 28. Another step 54 is positioning the liner 18 in the tub 12 wherein the lower surface 26 of the liner 18 contacts the tub 12 and the upper surface 24 of the liner 20 faces an interior space 66 of the tub. Yet another step 56 is filling the tub 12 with the liquid 18 wherein the liquid 18 contacts the upper surface 26 of the liner 20. Another step 58 is bathing a foot 68 in the liquid 18 in the tub 12. Still another step 60 is emptying the liquid 18 from the tub 12 and another step 62 is disposing of the liner 20.

With respect to the above description then, it is to be realized that the optimum dimensional relationships for the parts of an embodiment enabled by the disclosure. to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. An anti-bacterial and anti-fungal foot bath liner device comprising a liner, said liner having a perimeter edge, an upper surface and a lower surface, said upper surface of said liner being impregnated with silver nanoparticles wherein said liner is configured for preventing bacterial and fungal infection, said liner being configured for positioning in a tub wherein said upper surface of said liner lines the tub.

2. The device of claim 1, further comprising said liner having a lower layer and an upper layer, said upper surface being formed by an outwardly facing surface of said upper layer.

3. The device of claim 1, further comprising said liner being formed to include a planar lower portion and a perimeter wall extending upwardly from said lower portion.

4. The device of claim 1, further comprising said liner being flexible.

5. The device of claim 3, further comprising a lip extending from said perimeter wall of said liner, said lip being configured for extending over an upper edge of the tub.

6. An anti-bacterial and anti-fungal foot bath liner device comprising:
a tub having a peripheral wall and a closed bottom wherein said tub is configured for holding a liquid;
a flexible liner, said liner having a perimeter edge, an upper surface and a lower surface, said upper surface of said liner being impregnated with silver nanoparticles wherein said liner is configured for preventing bacterial and fungal infection, said liner being positioned in said tub wherein said upper surface of said liner lines said tub, said liner having a lower layer and an upper layer, said silver nanoparticles impregnating said upper layer of said liner, said upper surface of said liner being formed by an outwardly facing surface of said upper layer, said liner being formed to include a planar lower portion and a perimeter wall extending upwardly from said lower portion; and
a lip extending from said perimeter wall of said liner, said lip being configured for extending over an upper edge of the tub.

7. A method of preventing infection transmission in a foot bath, the steps of the method comprising:
having a tub and a liner, wherein an upper surface of said liner is impregnated with silver nanoparticles,
positioning said liner in said tub wherein a lower surface of said liner contacts said tub and said upper surface of said liner faces an interior space of said tub;
filling said tub with a liquid wherein said liquid contacts said upper surface of said liner; and
bathing a foot in said liquid in said tub.

8. The method of claim 7, the steps of the method further comprising;
emptying said liquid from said tub; and
disposing of said liner.
